(19) United States
(12) Patent Application Publication
(10) Pub. No.: US 2009/0084050 A1
(43) Pub. Date: Apr. 2, 2009

(54) Louver cover

(76) Inventors: Thomas W. Moore, Stratford, CT (US); Douglas A. Ziman, Stratford, CT (US)

Correspondence Address: WARE FRESSOLA VAN DER SLUYS & ADOLPHSON, LLP, BRADFORD GREEN, BUILDING 5, 755 MAIN STREET, P O BOX 224, MONROE, CT, 06468, US

(21) Appl. No.: 12/283,922

(22) Filed: Sep. 15, 2008

Related U.S. Application Data
(60) Provisional application No. 60/994,586, filed on Sep. 19, 2007.

(51) Int. Cl. E06B 3/30

(52) U.S. Cl. 52/203

(57) ABSTRACT

The present invention is directed to a louver cover dimensioned to substantially cover a louver of a central air conditioning system. The louver cover includes a member that is configured to face the louver, and a raised perimeter that is dimensioned to substantially surround the louver. The louver cover also includes at least one magnetic element that is configured to affix and remove the louver cover from the louver. The at least one magnetic element may be positioned on the member to engage at least one element of the louver that is attracted to a magnetic element, e.g. a ferrous containing element. The member may also have at least one groove positioned to accommodate a lever of the louver. The louver cover may also include a covering on the exterior surface of the louver cover facing away from the louver.

### CROSS REFERENCE TO RELATED APPLICATIONS

This application claims benefit of U.S. Provisional Application No. 60/994,586 filed Sep. 19, 2007, which is hereby incorporated by reference in its entirety.

### BACKGROUND OF THE INVENTION

Building heating and cooling systems are known, and may be configured for residential, commercial, or industrial applications. Many residential buildings have separate heating and cooling systems. For example, a residential building may have been originally built with baseboard or standing radiators for heating, and a central air conditioning system added at a later time. When the central air conditioning system is added, duct work is required in attic and possibly other areas with one or more louvers coming through the ceiling, walls or floor to deliver cool air from the air conditioning system to the rooms of the residential building. Such systems also require a large return louver centrally located in the residential building to provide return ventilation and air exchange. This example may also be applicable to commercial and industrial buildings.

During warmer months of the year, for example during the summer, central air conditioning systems work well, but when the air conditioning system is not in use, for example during cooler months of the year, the louvers in the ceiling allow drafts of cold air to fall from the duct work creating a chilling effect in the house or other building. An additional problem is created by the unused air conditioning duct work, in that heated air can rise into the louvers and into the cooler duct work and create condensation. The duct work can then become a breeding ground for mold, mildew and bacteria. These conditions may adversely affect the health of residents of the building.

Therefore, there is a need to cover the louvers in order to prevent heat loss, and help to reduce condensation accumulation in the duct work to lessen mold and mildew growth in the duct work.

### SUMMARY OF THE INVENTION

In accordance with an exemplary embodiment of the invention, a louver cover dimensioned to substantially cover an air conditioning system louver is provided that may include a member configured to face the louver, a raised perimeter affixed to the member and dimensioned to substantially surround a perimeter of the louver, and at least one magnetic element positioned on the louver cover, and configured to allow affixation and removal of the louver cover from the louver.

In accord with the exemplary embodiment of the invention, the member may be made of expanded polystyrene.

In accord with the exemplary embodiment of the invention, the raised perimeter may be made of expanded polystyrene.

In accord with the exemplary embodiment of the invention, the member may have a rectangular shape.

In accord with the exemplary embodiment of the invention, the member may have a square shape.

In accord with the exemplary embodiment of the invention, the raised perimeter may be further dimensioned to contact a wall surface adjacent to the perimeter of the louver when the louver cover is affixed to the louver.

In accord with the exemplary embodiment of the invention, the at least one magnetic element may be a ceramic magnet.

In accord with the exemplary embodiment of the invention, the at least one magnetic element may be a neodymium magnet.

In accord with the exemplary embodiment of the invention, the at least one magnetic element is positioned on the member so as to at least partially contact a magnetically attractive element of the louver when the louver cover is affixed to the louver.

In accord with the exemplary embodiment of the invention, the member may include at least one recess dimensioned to accommodate a lever of the louver.

In accord with the exemplary embodiment of the invention, the member may include a substantially flat surface dimensioned to face toward the louver.

In accord with the exemplary embodiment of the invention, the member may include at least one recessed formed in the substantially flat surface, and the at least one recess may be dimensioned to accommodate a level of the louver.

In accord with the exemplary embodiment of the invention, the louver cover may include additional recesses formed in the substantially flat surface, and each additional recess may be dimensioned to accommodate the level of the louver.

In accord with the exemplary embodiment of the invention, the member has a second flat surface opposite the substantially flat surface, and the second flat surface is dimensioned to face away from the louver.

In accord with the exemplary embodiment of the invention, the member may be made of a material suitable for painting on the second flat surface.

In accord with the exemplary embodiment of the invention, the louver cover may also include a box positioned on a side of the louver cover opposite the substantially flat surface and surrounding a surface of the raised perimeter.

In accord with the exemplary embodiment of the invention, the louver cover may also include a box positioned on a side of the louver cover opposite a substantially flat surface of the member dimensioned to face toward the louver, and the box is dimensioned to surround a surface of the raised perimeter.

### BRIEF DESCRIPTION OF THE DRAWINGS

Having thus described the invention in general terms, reference will now be made to the accompanying drawings, which are not necessarily drawn to scale, where:

FIG. 1 is a view of the side of the louver cover that faces the louver according to the present invention;

FIG. 2 is an angled isometric view of the side of the louver cover that faces the louver according to the present invention; and

FIG. 3 is a cross-sectional view of the louver cover according to the present invention.

### DETAILED DESCRIPTION OF THE INVENTION

The present invention now will be described more fully hereinafter with reference to the accompanying figures, in which exemplary embodiments of the invention are shown. The invention may, however, be embodied in many different forms and should not be construed as limited to the embodiments set forth herein. Like reference numerals refer to like elements throughout.

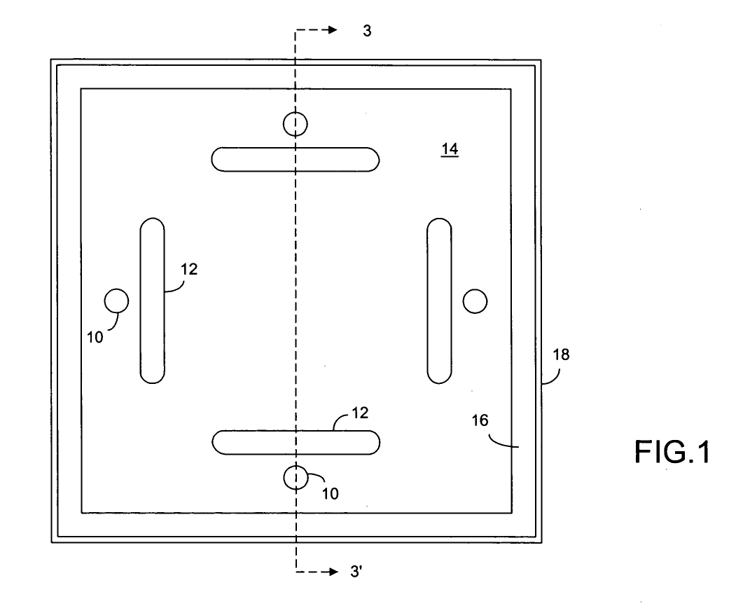

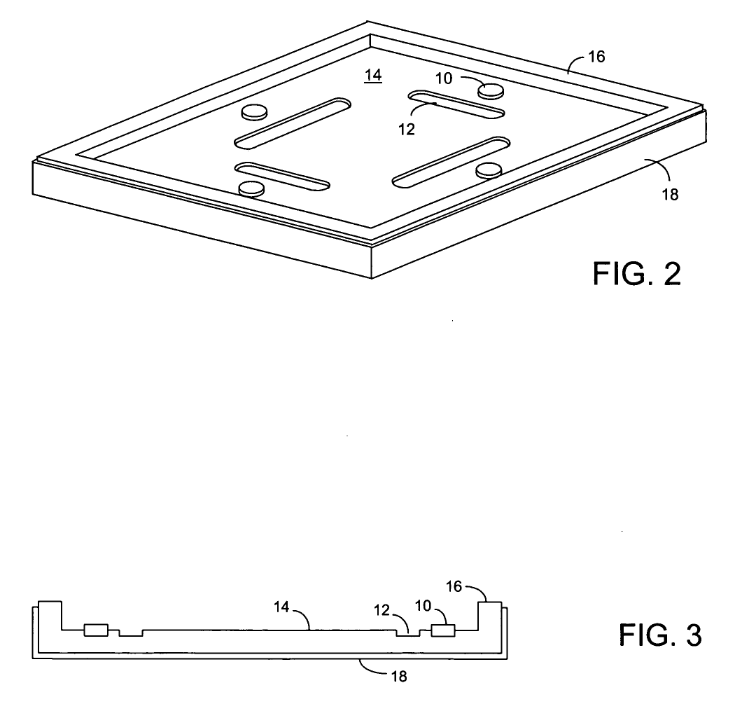

FIGS. 1-3 show an exemplary embodiment of the present invention. The louver cover shown in FIGS. 1-3 includes a member 14 dimensioned to substantially cover an air conditioning system louver. The member 14 may be made from expanded polystyrene thermal insulation (EPS), also known as STYROFOAM™, and may be any thickness, such as one inch thick. The member 14 may be made from insulation with different weights (weight per unit volume), such as one pound or two pound expanded polystyrene thermal insulation. The member 14 may have various sizes depending on the size of the louver, and may be rectangular or square depending on the shape of the louver. The louver cover also includes a raised perimeter 16 surrounding the member 14. The raised perimeter 16 extends from the member 14 a sufficient amount, for example one-half an inch, so that the raised perimeter 16 comes into close proximity or contact with the wall/ceiling surface adjacent to the louver. The distance the raised perimeter 16 extends from the member 14 may depend on the distance the louver cover extends from the wall/ceiling surface. The raised perimeter 16 may be formed by either routering out a solid piece of expanded polystyrene thermal insulation so that the member 14 is recessed from the raised perimeter 16, or by attaching pieces of expanded polystyrene thermal insulation that are thicker than the member 14 along the exterior perimeter of the member 14. The pieces of expanded polystyrene thermal insulation may be attached by suitable glue or other fasteners, e.g. pins, nails, etc.

The louver cover shown in FIGS. 1-3 may further include at least one magnet 10 to allow removable attachment of the louver cover to the louver. The magnets 10 may be glued to the member 14 using suitable glue known in the art, or glued into recesses formed in the member 14 dimensioned for receipt of the magnets 10. The magnets 10 may be, for example, ceramic or neodymium type magnets, and may be positioned on the member 14 to attach to magnetically attractive elements, e.g. metal screws containing iron used to fasten the louvers to the surrounding environment. Vent louvers are generally made from aluminum or vinyl, and therefore are not ferro-magnetic. Accordingly, the magnets 10 may be positioned on the member 14 so that when the louver cover is placed over the vent louver the magnets 10 are substantially aligned with the screws used to attach the vent louver to the wall/ceiling. The configuration of the vinyl louvers may require the use of a spacer (not shown) to hold and raise the magnet away from the expanded polystyrene thermal insulation member 14 in order to attach the magnet to the recessed screw heads. Return louvers are generally made from steel or another ferro-magnetic material, and therefore for louver covers designed to cover return louvers the magnets 10 may be glued along the edge of the member 14 adjacent to the raised perimeter 16. However, it is understood that for louver covers designed to cover return louvers the magnets 10 may be placed at any suitable location.

The louver cover may also include at least one recess 12 on the member 14 that is dimensioned to accommodate a lever of a vent louver. Vent louvers generally have a lever that allows a user to adjust the angel of dampers within the louver, and this lever protrudes from the exterior surface of the louver. Therefore, in order to allow the louver cover to come into close proximity or substantially contact the surface of the vent louver, at least one recess may be provided to accommodate the lever. The louver cover may have multiple recesses 12, for example four, so that a user of the louver cover does not have to align a single recess with the lever. The recesses 12 are positioned on the member 14 to substantially engage the lever, when the louver cover is placed over a vent louver.

The surface of the louver cover that faces away from the louver may be fitted with a covered box 18, such as a box made from cardboard. This box 18 may be made from 36 point cardboard, and the outside final layer may be made from a durable lacquer coated material to allow the louver cover to be painted with latex paint and to be periodically cleaned. The box 18 may be affixed to the louver cover by glue or other suitable means known to one of skill in the art. It is preferable to include the covered box 18 on the louver cover if the louver cover is made from one pound expanded polystyrene thermal insulation. However, it may be desirable to manufacture the louver cover without the covered box 18 if the louver cover is made from two pound expanded polystyrene thermal insulation.

It is to be understood that all of the present figures, and the accompanying narrative discussions of corresponding embodiments, do not purport to be completely rigorous treatments of the invention under consideration. It is to be understood that the above-described arrangements are only illustrative of the application of the principles of the present invention. Numerous modifications and alternative arrangements may be devised by those skilled in the art without departing from the scope of the present invention.

What is claimed is:

1. A louver cover dimensioned to substantially cover an air conditioning system louver, comprising:
a member configured to face the louver;
a raised perimeter affixed to the member and dimensioned to substantially surround a perimeter of the louver; and
at least one magnetic element positioned on the louver cover, and configured to allow affixation and removal of the louver cover from the louver.

2. The louver cover according to claim 1, wherein the member is comprised of expanded polystyrene.

3. The louver cover according to claim 1, wherein the raised perimeter is comprised of expanded polystyrene.

4. The louver cover according to claim 1, wherein the member has a rectangular shape.

5. The louver cover according to claim 1, wherein the member has a square shape.

6. The louver cover according to claim 1, wherein the raised perimeter is further dimensioned to contact a wall surface adjacent to the perimeter of the louver when the louver cover is affixed to the louver.

7. The louver cover according to claim 1, wherein the at least one magnetic element comprises a ceramic magnet.

8. The louver cover according to claim 1, wherein the at least one magnetic element comprises a neodymium magnet.

9. The louver cover according to claim 1, wherein the at least one magnetic element is positioned on the member so as to at least partially contact a magnetically attractive element of the louver when the louver cover is affixed to the louver.

10. The louver cover according to claim 1, wherein the member comprises at least one recess dimensioned to accommodate a lever of the louver.

11. The louver cover according to claim 1, wherein the member comprises a substantially flat surface dimensioned to face toward the louver.

12. The louver cover according to claim 11, wherein the member comprises at least one recessed formed in the substantially flat surface, wherein the at least one recess is dimensioned to accommodate a level of the louver.

13. The louver cover according to claim 12, further comprising additional recesses formed in the substantially flat surface, wherein each additional recess is dimensioned to accommodate the level of the louver.

14. The louver cover according to claim 13, wherein the member has a second flat surface opposite the substantially flat surface, and wherein the second flat surface is dimensioned to face away from the louver.

15. The louver cover according to claim 14, wherein the member is comprised of a material suitable for painting on the second flat surface.

16. The louver cover according to claim 12, further comprising a box positioned on a side of the louver cover opposite the substantially flat surface and surrounding a surface of the raised perimeter.

17. The louver cover according to claim 1, further comprising a box positioned on a side of the louver cover opposite a substantially flat surface of the member dimensioned to face toward the louver, and wherein the box is dimensioned to surround a surface of the raised perimeter.
